(19) United States
(12) Patent Application Publication
(10) Pub. No.: US 2014/0293648 A1
(43) Pub. Date: Oct. 2, 2014

(54) PERFORATED LIGHT-GUIDING PLATE AND METHOD FOR MANUFACTURING THE SAME

(71) Applicant: SHENZHEN ONWING OPTOELECTRONICS PRODUCTS CO., LTD, Shenzhen (CN)

(72) Inventor: Xi Liu, Shenzhen (CN)

(73) Assignee: SHENZHEN ONWING OPTOELECTRONICS PRODUCTS CO., LTD, Shenzhen (CN)

(21) Appl. No.: 14/199,762

(22) Filed: Mar. 6, 2014

(30) Foreign Application Priority Data
Apr. 2, 2013 (CN) 201310111774.7

(51) Int. Cl. F21V 8/00

(52) U.S. Cl. CPC G02B 6/006; G02B 6/0065
USPC 362/611; 427/163.2

(57) ABSTRACT

Disclosed is a perforated light-guiding plate, comprising a plate body (1) and a light source (3) arranged on a side of the plate body. A light-guiding hole (2) is arranged on at least one side face of the plate body. The present disclosure further discloses a method for manufacturing the perforated light-guiding plate. Various pores are fabricated on the surface of the light-guiding plate. The light distribution curve is regulated and controlled by punching holes inside the light-guiding plate and setting a direction of a punched hole (the light distribution curve of a traditional light-guiding plate is constant), thereby addressing an issue in which the light-guiding plate can only be used as an LED panel light by depending on a diffusion plate and improving practicability and artistry of the light-guiding plate.

### RELATED APPLICATIONS

This application claims priority to Chinese Application Serial Number 201310111774.7, filed Apr. 2, 2013, which is incorporated by reference herein in its entirety.

### TECHNICAL FIELD

The present disclosure relates to a light conduction apparatus, and in particular, to a light-guiding plate applicable to various illumination, artistic illumination, decorative illumination, decorative materials, show windows, cabinets, display stands, and the like and a method for manufacturing the same.

### BACKGROUND

A design principle of a light-guiding plate derives from a liquid crystal display of a laptop. The light-guiding plate converts line light source or point light source formed by a fluorescent lamp, CCFL, and LED light source that pass through a light-guiding point or a light-guiding groove calculated according to an optical principle to area source under an action of a tapetum lucidum (reflector plate) and a diffusion film.

The light shall pass various light-guiding points with different density and size to ensure that the light-guiding plate is capable of evenly lightening and reflection efficiency of the light in each direction is basically the same. The tapetum lucidum (reflector plate) is used to reflect the light revealed from an undersurface of the light-guiding plate back to the light-guiding plate, thereby improving service efficiency of the light and increasing luminance. A function of the diffusion film is to make the light more well-distributed and softer. The light-guiding plate is widely applied, for example, light-guiding illumination, decorative illumination, artistic illumination, backlight of TV, advertising, and indicating nameplate. The light-guiding points of the existing light-guiding plate are all adhered to a surface of the light-guiding plate. Manufacturing manners of the light-guiding plate include laser, silk screen, and etching, which are monotonous and cannot change a light distribution curve.

### SUMMARY

The present disclosure provides a perforated light-guiding plate that can change a light distribution curve and a method for manufacturing the same, to address an existing technical issue in which light-guiding points of a light-guiding plate are monotonous and the light distribution curve cannot be changed.

The present disclosure provides a perforated light-guiding plate, comprising a plate body and a light source arranged on a side of the plate body, wherein light-guiding holes are arranged in at least one side face of the plate body.

Preferably, the light-guiding holes are at least blind holes or through holes.

Preferably, the light-guiding holes are at least vertical holes or oblique holes.

Preferably, the light-guiding holes are at least circular holes, elliptical holes, or polygonal holes.

Preferably, the light-guiding holes are the same or different in size.

Preferably, the light-guiding points are arranged on opening of the light-guiding holes or on the plate body adjacent to the light-guiding holes.

Preferably, the light-guiding holes are arranged on one side face of the plate body, and the light-guiding points are arranged on the other side face of the plate body.

Preferably, the light-guiding holes and/or the light-guiding points form light-guiding grid dots, wherein light-guiding grid dots having different shapes, different sizes and different density distributions form various structures of graphic and text.

The present disclosure further provides a three-dimensional assembly in different shapes formed by the perforated light-guiding plate.

The present disclosure further provides a method for manufacturing the perforated light-guiding plate, comprising:

designing a pattern according to requirements, and arranging the pattern on a side face of a plate body of the light-emitting plate; or

arranging identical patterns on two side faces of the plate body of the light-guiding plate;

punching holes in one side face of the plate body of the light-guiding plate to fabricate light-guiding holes, wherein all the light-guiding holes form light-guiding grid dots, the light-guiding grid dots presenting a structure of the pattern; or

fabricating light-guiding holes on one side face of the plate body of the light-guiding plate, and fabricating light-guiding points on the other side face of the plate body of the light-guiding plate, wherein the light-guiding holes and the light-guiding points form light-guiding grid dots, the light-guiding grid dots presenting a structure of the pattern.

Various pores are fabricated on the surface of the light-guiding plate. The light distribution curve is regulated and controlled by punching holes inside the light-guiding plate and setting a direction of a punched hole (the light distribution curve of a traditional light-guiding plate is constant), thereby addressing an issue in which the light-guiding plate can only be used as an LED panel light by depending on a diffusion plate and improving practicability and artistry of the light-guiding plate. Market competitiveness can be significantly improved after light fixtures uses the perforated light-guiding plate to replace the panel light of the traditional LED light-guiding plate.

Compared with the prior art, the advantages of the present disclosure lie in that:

(1) An application scope of the existing light-guiding plate is narrow and design is limited. In terms of material selection, diffusion materials are required to address various glare issues. The present disclosure can completely get rid of the diffusion materials to address the glare issues. After the diffusion materials are replaced, the light passes various pores in the light-guiding plate and is directly derived in a diffusion manner, which can reduce power consumption, improve light efficiency, and reduce cost (reduce material cost on light source, diffusion, and the like).

(2) The present disclosure is more widely applied and has art appreciation. The present disclosure is not only applicable to illumination but also applicable to decoration, artware, and the like. The present disclosure features even and soft light, vivid and beautiful appearance, protean shape, and strong stereoscopic effect. The prolonged LED cooperates with the light-guiding plate to play a more important role in a key lighting product line. The present disclosure is more energy conservation and environment protection. A product is widely applied to various fields such as commercial illumination, artistic illumination, decorative illumination, artware, artwork, furniture illumination, decorative materials, advertising illumination, show windows, cabinets, display stands, exit signs, and guiding signs.

### BRIEF DESCRIPTION OF THE DRAWINGS

FIG. 1 and FIG. 2 are schematic front views of a rectangular light-guiding plate and a circular light-guiding plate according to the present disclosure;

FIG. 3 is a section view of a light-guiding plate equipped with a through hole and a blind hole on one side face;

FIG. 4 is a section view of a light-guiding plate equipped with a through hole and a blind hole on two side faces;

FIG. 5 is a section view of a light-guiding plate equipped with a vertical blind hole on one side face;

FIG. 6 is a section view of a light-guiding plate equipped with oblique blind holes in different directions on one side face;

FIG. 7 is a section view of a light-guiding plate equipped with a vertical blind hole and oblique blind holes in different directions on one side face;

FIG. 8 is a section view of a light-guiding plate equipped with a light-guiding point on opening of a blind hole on one side face;

FIG. 9 is a section view of a light-guiding plate equipped with a light-guiding point adjacent to opening of a blind hole on one side face;

FIG. 10 is a section view of a light-guiding plate equipped with a blind hole on one side face and a light-guiding point on the other side face;

FIG. 11a is a section view of a light-guiding plate equipped with a light-guiding hole on one side face and a light-guiding point on the other side face;

FIG. 11b is a left side face view of FIG. 11a; and

FIG. 11c is a right side face view of FIG. 11a.

### DETAILED DESCRIPTION

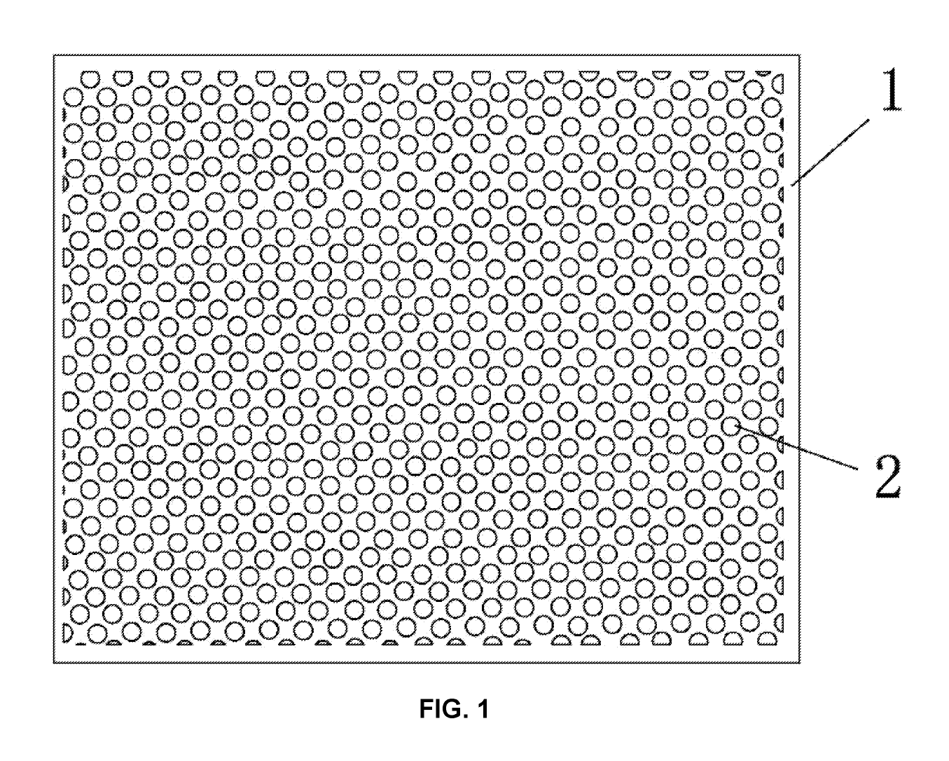

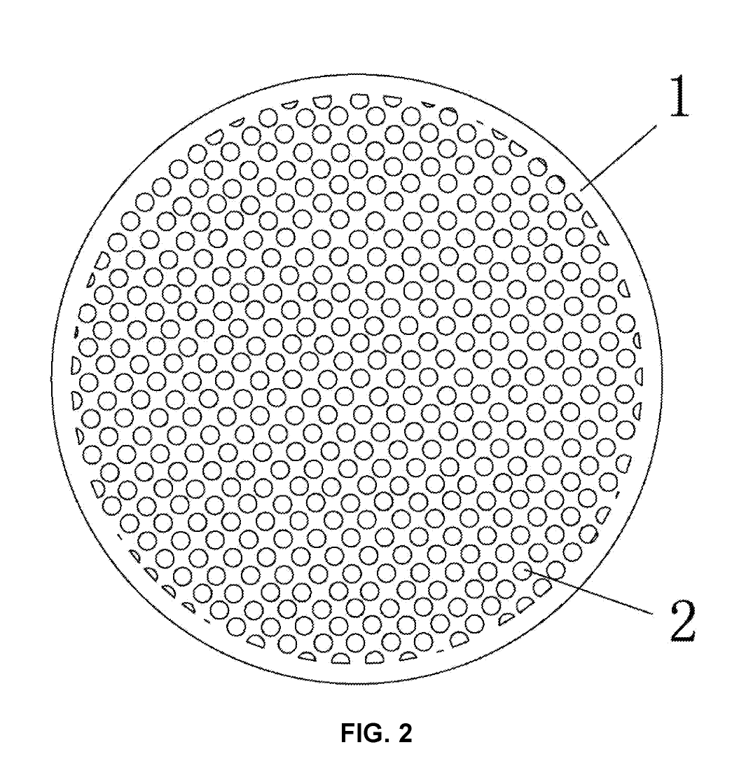

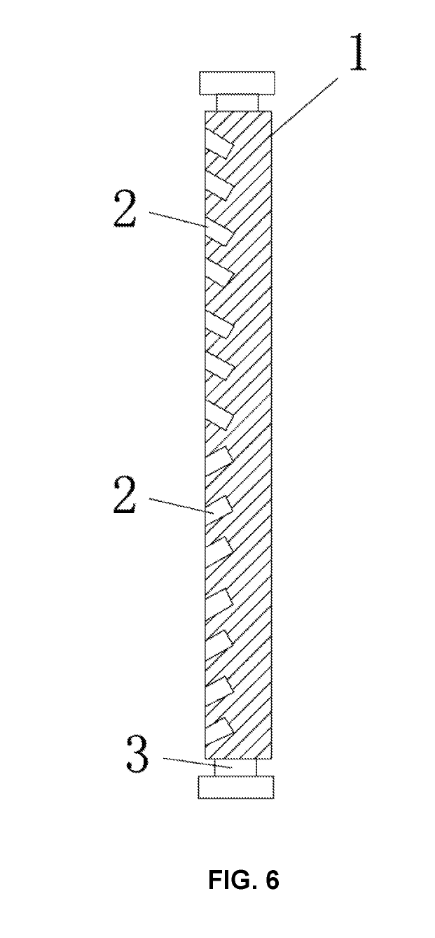

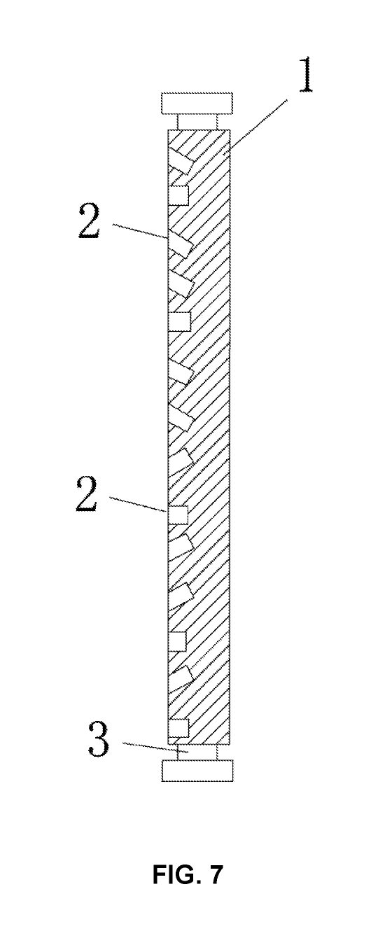

As illustrated in FIG. 1 to FIG. 10, the present disclosure provides a perforated light-guiding plate, comprising a plate body 1 and a light source 3 arranged on a side of the plate body 1, wherein light-guiding holes 2 are arranged in at least one side face of the plate body 1.

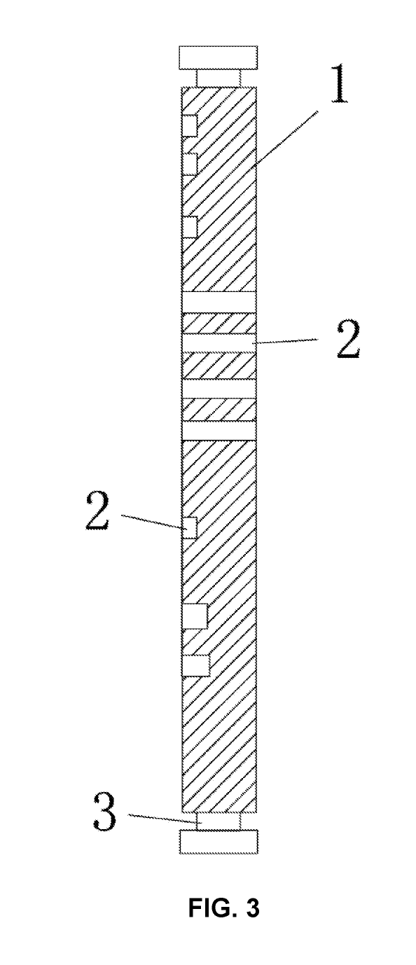

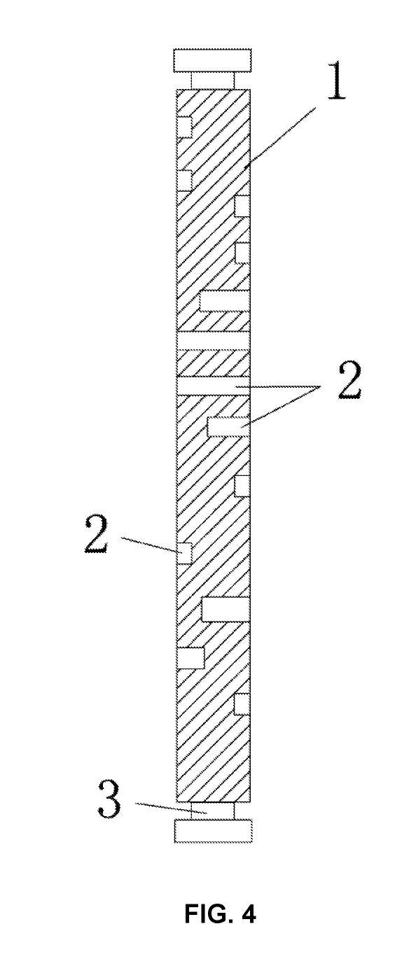

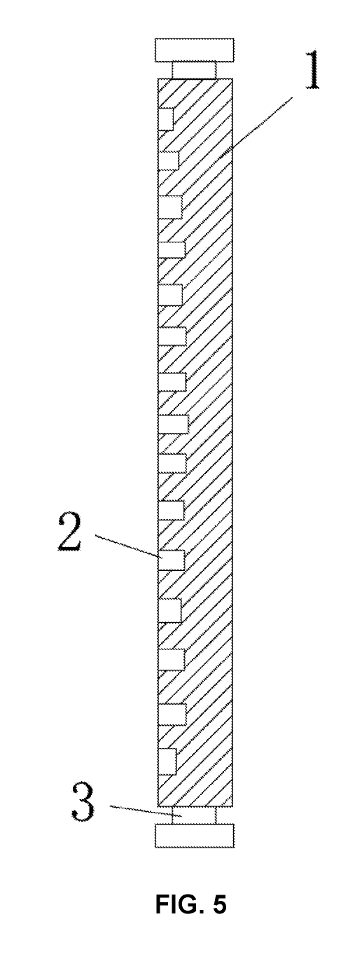

Referring to FIG. 3 and FIG. 4, the light-guiding holes 2 may be blind holes arranged on one side face or two side faces of the plate body 1, or may be a mixed configuration of blind holes and through holes, or may be all through holes. Referring to FIG. 5 to FIG. 7, the blind holes or the through holes 2 may be vertical holes or oblique holes, or may be a mixed configuration of vertical holes (90 degrees) and oblique holes (for example, 45 degrees, 35 degrees, or the like). The light-guiding holes 2 may be circular holes, elliptical holes, or polygonal holes; or may be any mixed configuration of vertical holes, oblique holes, and polygonal holes. The light-guiding holes 2 are of the same or different in hole diameter.

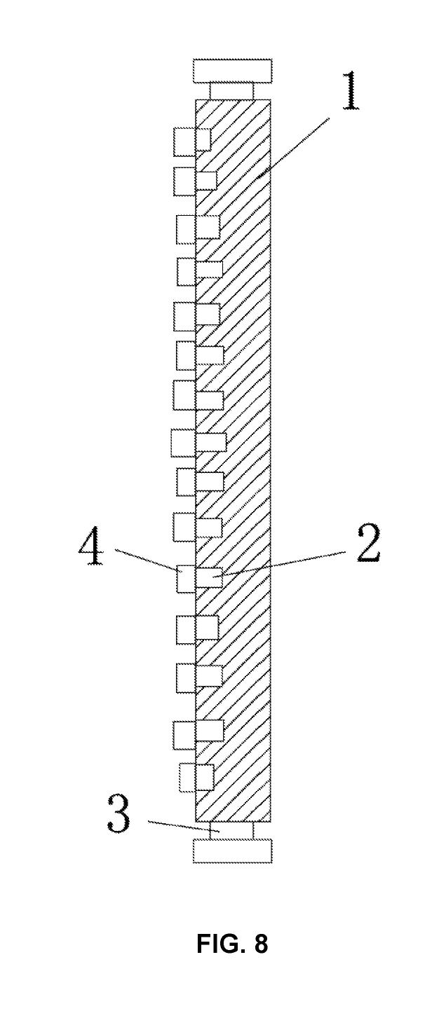

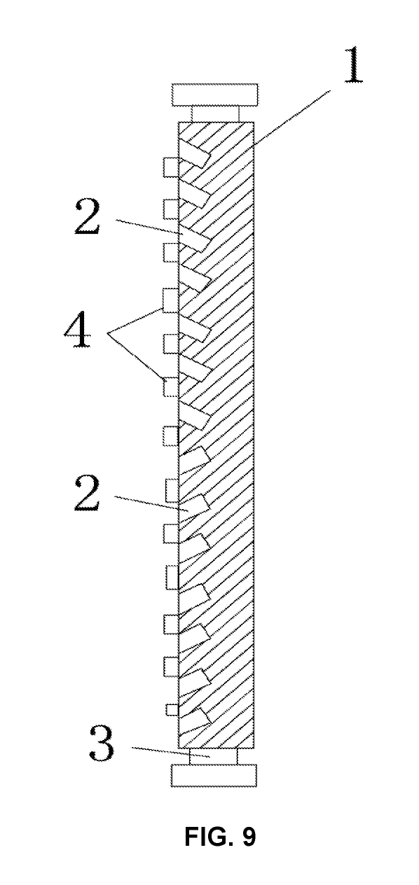

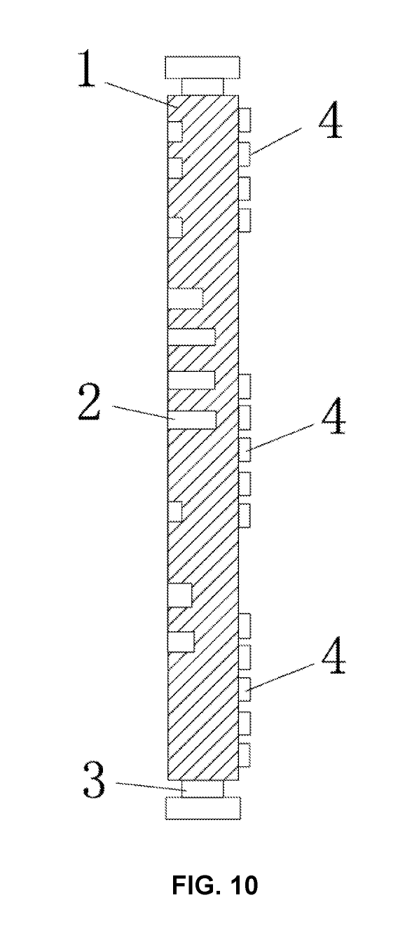

As illustrated in FIG. 8 and FIG. 9, light-guiding points 4 may be arranged on opening of the light-guiding holes 2, or light-guiding point 4 may be arranged on the plate body 1 adjacent to the light-guiding holes 2. According to practical requirements, the light-guiding points 4 may also be simultaneously arranged on the opening of the light-guiding holes 2 and the plate body 1 adjacent to the light-guiding holes 2. As illustrated in FIG. 10, the light-guiding holes 2 are arranged on the left side face of the plate body 1, and the light-guiding points 4 are arranged on the right side face of the plate body 1.

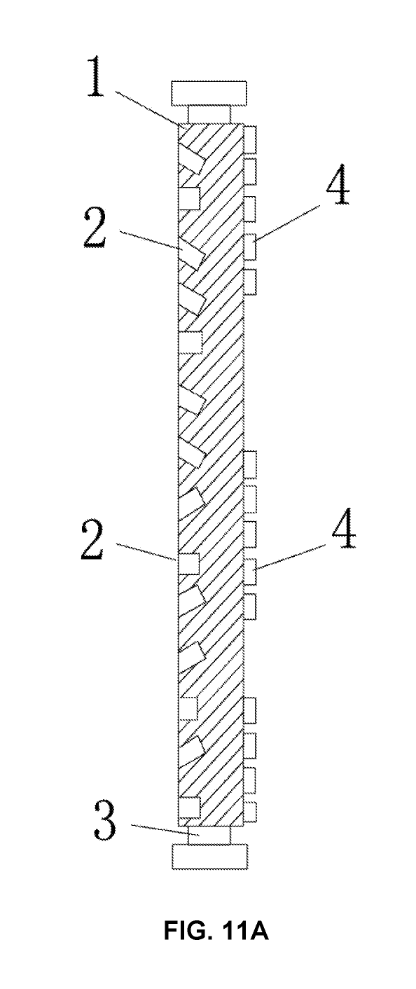

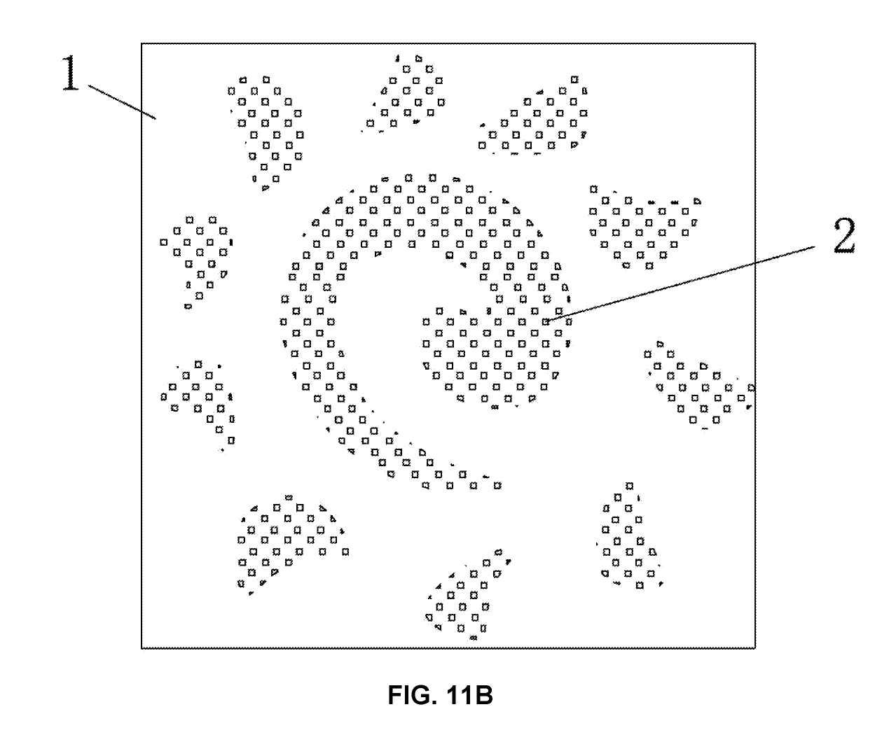

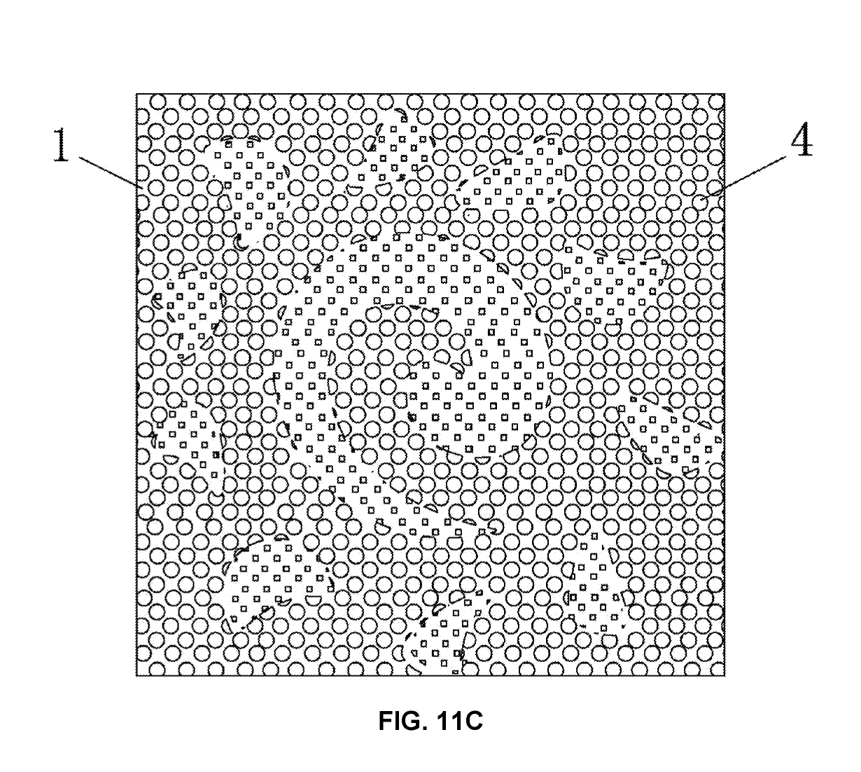

Referring to FIG. 11b and FIG. 11c, the light-guiding holes 2 and/or the light-guiding points 4 form light-guiding grid dots, wherein light-guiding grid dots having different shapes, different sizes and different density distributions may form various structures of graphic and text.

By using the perforated light-guiding plate according to the present disclosure, lighting fixtures having three-dimensional components in different shapes may be fabricated.

The present disclosure further provides a method for manufacturing the perforated light-guiding plate, comprising the following steps:

FIG. 11a, FIG. 11b, and FIG. 11c illustrate a preferred embodiment of the present disclosure.

Step 1: According to a market demand, design a pattern first (see FIG. 11b and FIG. 11c). Then, segment the pattern as follows: partial pattern used for fabricating the light-guiding hole 2 on the left side face of the light-guiding plate 1 and partial pattern used for fabricating the light-guiding point 4 on the right side face of the light-guiding plate 1. In this embodiment, the light-guiding point 4 adopts silk-screen printing. Therefore, this part of pattern requires screen printing plate fabrication.

Step 2: Arrange the pattern used for fabricating the light-guiding hole on the left side face of the light-guiding plate 1, and use a laser device to fabricate a mixture of the vertical blind hole 2 and the oblique hole 2, as shown in FIG. 11a. Then, use the screen printing plate to fabricate the light-guiding point 4 on the left side face of the light-guiding plate by means of silk-screen printing. The light-guiding hole 2 and light-guiding point 4 form the light-guiding grid dots. The integrity of the light-guiding grid dots can present a structure of a pattern.

After the fabrication on the front and back sides is complete, a complete and stereo pattern is provided. After an indicator is on, the light-guiding plate generates a stereo pattern, and the brightness and ornamental value are improved. The light-guiding grid dots have different shapes, different sizes, and different density distributions, and the light-guiding grid dots having different shapes, different sizes and different density distributions form various structures of graphic and text. The graphic and text is any one of Chinese character, letter, or pattern, or is a combination of Chinese character, letter, and pattern.

According to an requirement, the light-guiding hole 2 grid dots can also be fabricated only at one side face of the light-guiding plate at a time, that is, the light-guiding point 4 does not need to be fabricated on the other side face of the light-guiding plate. The light-guiding hole 2 can be used for fabricating a laser device and can also be used for fabricating another device (laser, etching, and modeling can be used for punching holes). The light-guiding point 4 can be fabricated by printing, engraving, etching, or modeling. The material for the light-guiding plate 1 can be a transparent material such as acrylic, glass, plastic, and crystal.

Various pores are fabricated on the surface of the light-guiding plate. The light distribution curve is regulated and controlled by punching holes inside the light-guiding plate and setting a direction of a punched hole (the light distribution curve of a traditional light-guiding plate is constant), thereby addressing an issue in which the light-guiding plate can only be used as an LED panel light by depending on a diffusion plate and improving practicability and artistry of the light-guiding plate.

Described above are merely exemplary embodiments for illustrating the present disclosure. It should be noted that persons of ordinary skill in the art may derive various variations and modifications without departing from the inventive concept of the present disclosure. Such variations and modifications shall pertain to the protection scope of the present disclosure.

What is claimed is:

1. A perforated light-guiding plate, comprising a plate body (1) and a light source (3) arranged on a side of the plate body, wherein light-guiding holes (2) are arranged in at least one side face of the plate body.

2. The perforated light-guiding plate according to claim 1, wherein the light-guiding holes (2) are at least blind holes or through holes.

3. The perforated light-guiding plate according to claim 2, wherein the light-guiding holes (2) are at least vertical holes or oblique holes.

4. The perforated light-guiding plate according to claim 1, wherein the light-guiding holes (2) are at least circular holes, elliptical holes, or polygonal holes.

5. The perforated light-guiding plate according to claim 1, wherein the light-guiding holes (2) are the same or different in size.

6. The perforated light-guiding plate according to claim 1, wherein light-guiding points (4) are arranged on opening of the light-guiding holes (2) or on the plate body (1) adjacent to the light-guiding holes (2).

7. The perforated light-guiding plate according to claim 1, wherein the light-guiding holes (2) are arranged on one side face of the plate body (1), and the light-guiding points (4) are arranged on the other side face of the plate body (1).

8. The perforated light-guiding plate according to claim 7, wherein the light-guiding holes (2) and/or the light-guiding points (4) form light-guiding grid dots, wherein light-guiding grid dots having different shapes, different sizes and different density distributions form various structures of graphic and text.

9. A three-dimensional assembly in different shapes formed by the perforated light-guiding plate according to claim 1.

10. A method for manufacturing the perforated light-guiding plate according to claim 1, comprising:
designing a pattern according to requirements, and arranging the pattern on a side face of a plate body of the light-emitting plate; or arranging identical patterns on two side faces of the plate body of the light-guiding plate;
punching holes in one side face of the plate body of the light-guiding plate to fabricate light-guiding holes, wherein all the light-guiding holes form light-guiding grid dots, the light-guiding grid dots presenting a structure of the pattern; or
fabricating light-guiding holes on one side face of the plate body of the light-guiding plate, and fabricating light-guiding points on the other side face of the plate body of the light-guiding plate, wherein the light-guiding holes and the light-guiding points form light-guiding grid dots, the light-guiding grid dots presenting a structure of the pattern.
